(19) United States
(12) Patent Application Publication
(10) Pub. No.: US 2008/0254189 A1
(43) Pub. Date: Oct. 16, 2008

(54) Process for Making Tea Extracts

(76) Inventor: Nikolaos Mavroudis, Vlaardingen (NL)

Correspondence Address: UNILEVER PATENT GROUP, 800 SYLVAN AVENUE, AG West S. Wing, ENGLEWOOD CLIFFS, NJ, 07632-3100, US

(21) Appl. No.: 11/663,944

(22) PCT Filed: Sep. 21, 2005
(86) PCT No.: PCT/EP05/10376

§ 371 Date: Mar. 27, 2007

(30) Foreign Application Priority Data
Oct. 1, 2004 (GB) 0421827.7

(51) Int. Cl. A23F 3/16

(52) U.S. Cl. 426/597

(57) ABSTRACT

The invention concerns a process for provising a tea extract which is rich in naturally occuring theanine. The process involves a cold water extraction followed by a specific nanofiltration step. Also claimed are the cold water extracts.

The present invention relates to a process for making theanine-rich tea extract.

### BACKGROUND AND PRIOR ART

Tea is generally prepared as green leaf tea or black leaf tea. The method of preparing such teas is well known to those skilled in the art. Generally, to prepare black leaf tea, fresh green leaves of the plant Camellia sinensis are withered (subjected to mild drying), comminuted, fermented (in which enzymes in the leaf tea oxidise various substrates to produce brown-coloured products) and then fired (to dry the tea leaves). Green leaf tea is not exposed to the fermentation process. Partial fermentation may be used to produce intermediate-type teas known as “oolong” tea.

Today tea based beverages can be prepared by methods other than infusing leaves in hot water and served in ways other than poured from tea pots. For example they can be made with concentrates or powders that are mixed with hot water in vending machines or used to prepare ready to drink teas in cans and bottles. Consumers also demand more from tea such as accelerated infusion, more colour, more aroma.

In particular the modern consumer is particularly interested in naturally healthy beverages which form part of a modern healthy lifestyle. As a beverage, tea fits well with this attitude in view of its natural content of inter alia flavonoids, catechins and amino acids. There is therefore a need in the art to provide a method for the concentration of these naturally occurring healthy ingredients whilst maintaining the healthy nature of tea without adding synthetic compounds.

One such ingredient is theanine. Theanine has been found to have numerous beneficial effects on the human body and mind. However, currently this is only available in high quantities in a synthetic sun-theanine form. This is largely due to the fact that naturally occurring theanine only comprises about 1% of the extractable tea solids in tea plant material.

GB 559,758 discloses a cold water infusion followed by a hot water infusion of black tea leaves. The cold water extract and the hot water extract are separately dried to a powder. The cold water infusion step takes at least 4 hours.

EP 110 391 discloses a cold water infusion followed by a hot water infusion of black leaf tea in order to provide an instant cold water-soluble ice tea powder. The cold water infusion step is shorter than in GB 559,758, and is exemplified by an extraction at room temperature for 10 minutes. The two extracts are mixed together, the mixture is then concentrated and then dried.

EP 267 660 again discloses a cold water infusion followed by a hot water infusion of black leaf tea but in order to provide a hot-water instant tea powder.

O. Kuntze, “Effect of extraction temperature on cream and extractability of black tea” Int. Journal of Food Sci and Tech (2003), 38, 37-45 discloses that a water extraction of as high as 50° C. results in the majority of the components responsible for formation of the cream remain unextracted. However, because an extraction at 50° C. gives a low yield, leaving a large amount of tea solids in the leaf, the paper suggests that a second infusion at 90° C. could follow so that the remaining tea solids can be extracted for normal hot drinking instant tea purposes.

WO2005/042470 discloses a process for extracting theanine from tea comprising the steps of extraction, contact with an adsorbent and then filtration. This does not disclose a short cold extraction and the preferred initial extraction involves steeping tea leaves in hot water.

The present inventors have discovered that performing a short cold water extraction on fermented tea leaves, provides a very effective way of extracting a high percentage of theanine from the tea leaves whilst leaving behind the vast majority of the remaining tea solids. However the composition of the tea solids in a cold-water extract are naturally limited to relative solubility's of the tea solids in the tea plant and are unlikely to comprise more than 6 wt % theanine. Therefore there remains a need in the art for a method of providing an even higher naturally occurring theanine concentration tea extract.

Thus, the present invention provides a process to provide a theanine-rich tea extract comprising the steps of:
(i) performing a cold water extraction of tea plant material using water at a temperature of from 1 to 50° C. for a time period of from 1 to 120 minutes to provide a cold-water tea extract;
(ii) passing the extract through a microfiltration and a nanofiltration step wherein the nanofilter has a theanine rejection of less than 50% to provide a permeate having tea solids comprising from 8 to 40 wt % theanine.

In a second aspect, the invention provides a cold-water tea extract comprising tea solids, characterised in that the tea solids comprise from 8 to 40 wt % naturally occurring theanine.

### DETAILED DESCRIPTION OF THE INVENTION

Tea Starting Material

The starting material of the present invention is tea plant material. Material from Camellia sinensis, Camellia assamica, or Aspalathus linearis. Preferably the starting material is black tea, in which the leaves and/or stem are subjected to a so-called “fermentation” step wherein they are oxidised by certain endogenous enzymes that are released during the early stages of “black tea” manufacture. This oxidation may even be supplemented by the action of exogenous enzymes such as oxidases, laccases and peroxidases. The fermentation process is believed to polymerise the polyphenols which may cause difficulties with the sensitive filters used in the present invention.

Cold Water Extraction

The cold water extraction is carried out with water at a temperature of from 1 to 50° C. for a time period of from 1 to 120 minutes. Preferably, the temperature and duration are such that the product of the temperature in degrees Celsius and the duration of the extraction in minutes (Cmins) is from 30 to 1000, preferably from 100 to 500.

The cold water extraction step may be carried out in a batchwise or continuous manner. When run continuously, the extraction time refers to the mean residence time of the tea leaf.

Preferably the water is at a temperature of from 3 to 30° C., preferably from 5 to 20° C.

Preferably the extraction is for a time period of from 5 to 60 minutes, or even from 10 to 45 minutes.

The extraction may be carried out in any suitable contacting equipment, for example a stirred tank.

Preferably the water-to-leaf weight ratio is from 5:1 to 50:1, more preferably from 10:1 to 30:1.

Following extraction the extract is preferably filtered to remove the leaves. The liquor is then preferably centrifuged to remove any coarse material which manages to pass through the filter. Another preferential step is demineralisation of the liquor.

Preferably, the cold-water extract is also demineralised by any suitable process known in the art.

Nanofiltration Step

The nanofiltration is preferably preceded by a microfiltration step as is conventional in the art, in order to protect the nanofilter from coarse particles. Preferably the microfiltration step uses a filter with a pore size of 0.2 micrometres.

The purpose of the nanofiltration step is to enrich the theanine content of the tea solids in the cold-water extract. A cold-water extract will contain tea solids having approximately 6 wt % theanine. Thus, concentration to a powder would result in a 6 wt % theanine powder.

It is an essential feature of the present invention that the cold-water extract is passed through a nanofilter having a theanine rejection of less than 50%. In this way, the majority of the theanine passes through the filter but the majority of unwanted tea solids remains in the retentate. A single pass through such a filter can double the concentration of theanine in the dry solids.

As the person skilled in the art will understand, nanofilters are characterised in a number of ways according to their intended purpose. It is not physically meaningful to characterise them with an equivalent pore size, as in microfiltration. For the purposes of the present invention, a commercially available nanofilter must be characterised to obtain its theanine rejection percentage. This is carried out at room temperature with a TMP of 5.1 bar and using a theanine solution of concentration 200 to 400 mg/l. For example, the following commercially available filters were characterised and their theanine rejection percentages measured:

TABLE 1

| Membrane | Theanine rejection % |
|---|---|
| Nitto-Denko NTR 7450 | 7 |
| Trisep NX45 | 35 |
| Dow NF90 | 86 |
| Dow-Filmtec. NF200 | 79 |
| Osmonics DK | 87 |
| Osmonics DL | 88 |

Only the NTR 7450 and the Trisep NX45 are suitable nanofilters from the six nanofilters in table 1.

Optional Concentration Step

Usually the enriched extract will need to be concentrated because it normally comprises over 99 wt % water. This may be achieved by passing the enriched extract through another nanofilter, however, this time one with a theanine rejection of greater than 80%. In this way, a retentate is provided with most of the theanine but with an order of magnitude less water.

Another way of concentrating is to use reverse osmosis. Such a process will act as a purely concentration step as only water is permitted to pass the filter in such a process.

Because of the thermal instability of theanine, it is preferred that the concentration step does not involve the temperature of the extract exceeding 80 for more than 20 minutes and does not exceed 60 for more than 40 minutes.

The cold water extract can be further concentrated to form a liquid concentrate or a powdered cold water extract. This may be achieved by freeze drying for example. The final concentrate can comprise at least 20 wt %, preferably at least 40 wt %, preferably at least 60 wt %, more preferably at least 80 wt % tea solids.

Preferably the cold-water extract is also treated with polyvinyl pyrolidone to precipitate polyphenolics.

Optional Hot Water Extraction

When the cold water extraction of the present invention is carried out, the tea leaves are such that they can still be used for the purposes of providing tea extract in a conventional ice tea production process. Therefore there is no waste of tea leaves whilst also obtaining good extraction of the amino acids.

### EXAMPLES

Black tea leaves were infused in water at a temperature of 5° C. for a duration of 10 minutes (Cmins=50). The tea leaves were separated from the liquor which was then centrifuged to remove coarse material, leaving an aqueous tea extract having 0.58 wt % dry solids comprising 5.9 wt % theanine upon analysis.

The liquor was then passed through a 0.2 micrometre microfiltration step, to remove any fractions which could damage the nanofilter. The permeate was then passed through a nanofiltration step using a Trisep NX45 filter, resulting in a permeate having 0.065 wt % dry solids but comprising 15 wt % theanine upon analysis.

The permeate was passed through a reverse osmosis step to remove water, yielding a liquor having approximately 10 wt % dry solids, comprising 15 wt % theanine. Such a liquor could be further freeze dried to provide a 15 wt % theanine powder.

1. A process to provide a theanine-rich tea extract comprising the steps of:
(i) performing a cold water extraction of tea plant material using water at a temperature of from 1 to 50° C. for a time period of from 1 to 120 minutes to provide a cold-water tea extract;
(ii) passing the extract through a nanofiltration step wherein the nanofilter has a theanine rejection of less than 50% to provide a permeate having tea solids comprising from 8 to 40 wt % theanine.

2. A process according to claim 1, wherein the starting material is fermented tea plant material.

3. A process according to claim 1, wherein the starting material comprises tea stem.

4. A process according to claim 1, wherein the water is at a temperature of from 3 to 30° C., preferably from 5 to 20° C.

5. A process according to claim 1, wherein the cold-water extract is also demineralised.

6. A process according to claim 1, wherein the cold water extraction is for a time period of from 5 to 60 minutes.

7. A process according to claim 1, wherein a hot water extraction is performed on the tea leaves which have been cold-water extracted using water at a temperature of from 50 to 100° C. to provide a hot-water tea extract.

8. A process according to claim 7, wherein the retentate from the microfiltration step is fed to the hot extraction step.

9. A process according to claim 7, wherein the retentate from the nanofiltration step is fed to the hot extraction step.

10. A process according to claim 1, wherein the cold-water extract is also treated with polyvinyl pyrolidone to precipitate polyphenolics.

11. A cold-water tea extract comprising tea solids, characterised in that the tea solids comprise from 8 to 40 wt % naturally occurring theanine.

12. A cold-water tea extract according to claim 11, comprising more than 98 wt % water and less than 2 wt % tea solids.

13. A cold-water tea extract according to claim 11, comprising from 40 to 100 wt % tea solids.

14. A cold-water tea extract according to claim 11, wherein the tea solids comprise from 10 to 25 wt % naturally occurring theanine.
